(19) United States
(12) Patent Application Publication
(10) Pub. No.: US 2019/0095378 A1
(43) Pub. Date: Mar. 28, 2019

(54) SELECT COMMUNICATIONS AND DATA ASPECTS OF POOL AND SPA EQUIPMENT SUCH AS SALT-WATER CHLORINATORS

(71) Applicant: ZODIAC POOL SYSTEMS LLC, Vista, CA (US)

(72) Inventors: Eusebio D. Bareng, Vista, CA (US); Dindo Uy, Vista, CA (US)

(73) Assignee: ZODIAC POOL SYSTEMS LLC, Vista, CA (US)

(21) Appl. No.: 16/122,356

(22) Filed: Sep. 5, 2018

Related U.S. Application Data
(60) Provisional application No. 62/561,763, filed on Sep. 22, 2017.

(51) Int. Cl. G06F 13/42; G06F 13/40; G06F 1/26

(52) U.S. Cl. CPC G06F 13/4282; C02F 1/4674; G06F 1/266; G06F 13/4068

(57) ABSTRACT

Methods and systems for effecting electronic communication to, from, and within salt water chlorinators (SWCs) are detailed. Information relating to operating times of SWCs at different levels of energization may be obtained, as may information respecting authenticity of the SWCs themselves. Two-way serial communication may be established between a master device and an SWC, with the master also supplying power to the SWC if needed.

### CROSS-REFERENCE TO RELATED APPLICATION

This application claims the benefit of and priority to U.S. Provisional Patent Application Ser. No. 62/561,763, filed Sep. 22, 2017, and having the same title as appears above (the “Provisional Application”), the entire contents of which Provisional Application are hereby incorporated herein by this reference.

### FIELD OF THE INVENTION

This invention relates to serially communicating data to and from pool and spa equipment such as salt-water chlorinators (“SWCs”) as well as collecting data relating to, e.g., operating times of electrolysis cells of SWCs at different levels of energization.

### BACKGROUND OF THE INVENTION

U.S. Patent Application Publication No. 2014/0326680 of Mastio details, among other concepts, use of sensors in connection with SWCs. As discussed therein, an SWC may electrolyze a sodium salt dissolved in pool water so as to produce sanitizing agents such as hypochlorous acid and sodium hypochlorite. “The electrolysis is achieved by passing a current through adjacent conductive plates immersed in the pool water.” See Mastio, p. 1, ¶0003. Because electricity is necessary for electrolysis, an SWC of the Mastio application may include electrical contacts “for connection with an electrical source.” See id., p. 3, ¶0048.

Also disclosed in the Mastio application are various sensors useful as part of an SWC. Exemplary sensors may “detect the concentration of sodium chloride and/or sodium bromide in the pool water flowing through the channel” of the chlorinator. See id., ¶0052. Alternatively or additionally, they may sense pH level or other characteristics of the pool water. See id., ¶0053. In either circumstance, the sensors “may be in communication with a processor via a cable or wireless connection.” See id., ¶0052. The entire contents of the Mastio application are incorporated herein by this reference.

### SUMMARY OF THE INVENTION

At least one version of the present invention provides schemes and equipment for effecting electronic communication of information to, from, and within SWCs. The invention also relates to gathering information as to at least operating times of SWCs at different levels of energization. Time-varying information in respect of other parameters (e.g. water salinity, voltage applied to a cell) additionally may be collected. Authenticity of an SWC—as, for example, a product of a particular manufacturer—may be queried and obtained as data from the SWC.

Conventional serial communication apparatus utilize a dedicated pair of wires to communicate between master and servant devices. If a servant device requires electrical power to operate, an additional pair of wires is needed. Hence, typical communication buses include either four wires (transmit and receive wires for communication; power and ground wires for electricity) or three wires (a transmit/receive wire for communication; power and ground wires for electricity).

The present invention, by contrast, accomplishes such communication using only two wires. As with conventional approaches, one wire may simply function as a ground wire. The other, however, may function not only to provide power, but also to effect transmission and reception of data.

It thus is an optional, non-exclusive object of the present invention to provide methods and systems for effecting communication to, from, and within SWCs.

It is another optional, non-exclusive object of the present invention to provide two-wire serial communication between at least two electronic devices.

It is also an optional, non-exclusive object of the present invention to provide connections between at least two electronic devices through which both power and data may be supplied.

It is an additional optional, non-exclusive object of the present invention to provide communication methods and systems in which data sent to an electronic device is modulated in a manner different than data sent from the electronic device.

It is, moreover, an optional, non-exclusive object of the present invention to provide methods and systems in which time-varying information respecting an SWC, such as operating times of the SWC at different levels of energization, may be obtained.

It is a further optional, non-exclusive object of the present invention to provide methods and systems in which authenticity of SWCs may be queried.

Other objects, features, and advantages of the present invention will be apparent to persons skilled in the relevant art with reference to the remaining text and the drawings of this application.

### BRIEF DESCRIPTION OF THE DRAWINGS

FIG. 1 is a schematic illustration of aspects of the present invention.

FIG. 2 is a schematic illustration of the aspects of FIG. 1 used in connection with an SWC.

FIG. 2A is a schematic illustration of a servant device consistent with FIG. 2.

### DETAILED DESCRIPTION OF THE DRAWINGS

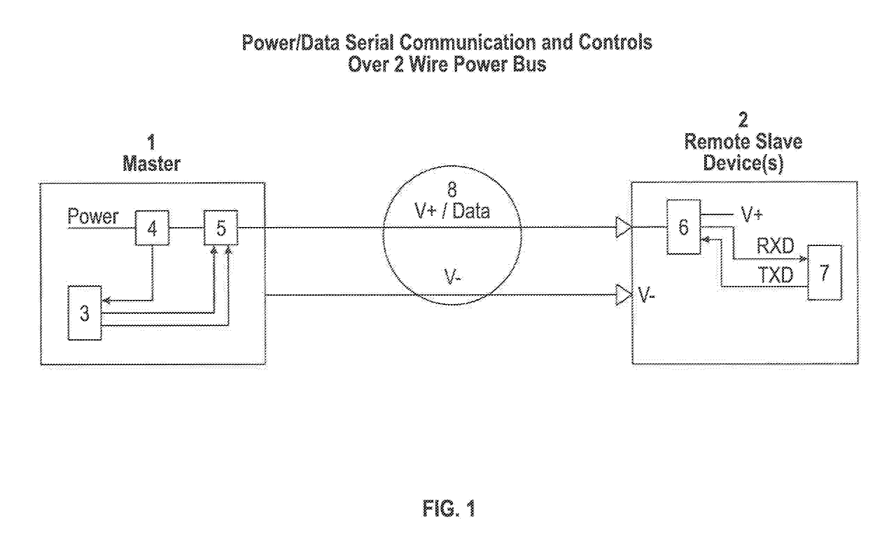

FIG. 1 schematically illustrates a two-wire bus consistent with the invention. Bus 8 includes two wires connecting master device 1 and slave (servant) device 2. Master device 1 is configured to send data to remote servant device 2 and receive data therefrom, hence establishing two-way serial communication between them. Master device 1 also may provide electrical power to servant device 2.

Master device 1 may include a computerized controller, such as micro-controller 3, as well as voltage modulator 5. Using voltage modulator 5, data to be sent to servant device 2 preferably may be modulated onto the voltage provided in order to furnish power to the servant device 2. Detecting device 4 of master device 1 may detect and demodulate data from servant device 2 to the master device 1, which data preferably is current-modulated (rather than voltage modulated). Although these types of modulation are preferred, persons skilled in the art will recognize that other modulation techniques may be employed instead if desired.

Servant device 2 may comprise a controller such as micro-controller 7 together with detecting device 6, which may function as a current modulator and as a voltage regulator for micro-controller 7. Noted in text initially presented in the Provisional Application are these examples of features of the system of FIG. 1:
1. Provide power from Master to remote slave device(s).
2. 2 way serial communication between Master and Remote slave device(s).
3. Reset control to remote slave device(s) without turning off power.
4. Power control from Master.
5. Voltage Modulation (VM) or Amplitude Shift Key (ASK) or Frequency Shift Key (FSK) communication from Master to remote slave device(s).
6. Current Modulation (CM) or Amplitude Shift Key (ASK) or Frequency Shift Key (FSK) communication from remote slave device(s) to Master.
7. Voltage Level Control from Master to remote slave device(s).
8. Proprietary 32 bits 2 way authentication between Master and Remote slave device(s).
9. Digital input/output and analog sensor inputs in remote slave.
10. Device run-time storage in remote slave.

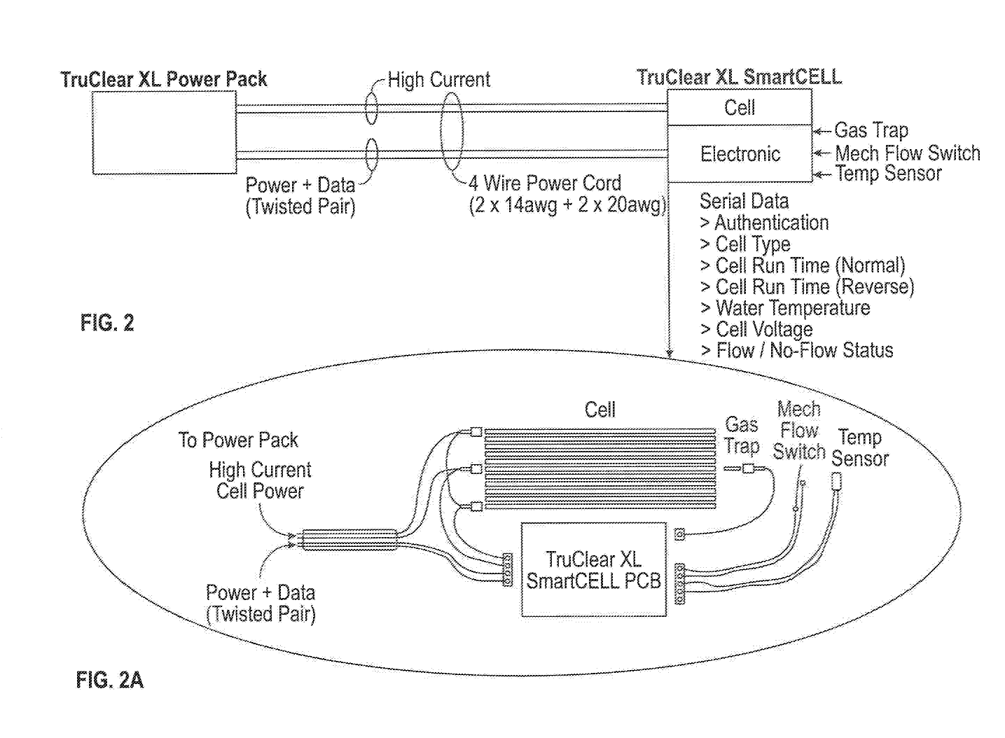

FIG. 2 schematically illustrates use of the system of FIG. 1 in connection with an SWC. The block of FIG. 2 labeled “TruClear XL Power Pack” may equate to master device 1, whereas the block labeled “TruClear XL SmartCELL” may operate as a servant device 2. The connection labeled “Power+Data” may be formed by bus 8. FIG. 2 lists exemplary data sets that may be passed between devices 1 and 2 as well as exemplary sensors and components that may be included as part of the servant device 2 when an SWC.

Master device 1 additionally may provide electrical power in order to operate electronics of the SWC forming servant device 2. FIG. 2A depicts bus 8 as being connected to the “TruClear XL SmartCELL PCB,” which may contain such electronics. Hence, using only the two wires of bus 8, both power and data may be transferred between devices 1 and 2.

FIG. 2A further illustrates servant device 2. When an SWC, device 2 may comprise an electrolytic cell comprising a series of plates. Power to the plates may be provided along “High current” wires, which are separate from bus 8 and shown as being connected to the plates. Voltage and current provided over the “High Current” wires typically will be substantially higher than that provided over the “Power+Data” wires. Both the plates and sensors/components (such as the listed Gas Trap, Mech. Flow Switch, and Temp. Sensor) may be electrically connected to a micro-controller such as present on the “TruClear SmartCELL PCB” of FIG. 2A, as may bus 8.

The SWC typically will be part of a water-circulation system of the swimming pool or spa. Persons skilled in the relevant art will recognize, however, that servant device 2 need not necessarily be an SWC. Instead, device 2 may be any appropriate electronic device, including (but not limited to) any other component of the water-circulation system capable of transmitting and receiving data electronically.

Further contemplated in connection with the present inventions is data gathering of not merely how long an SWC cell has been operating, but at what level of energization as well. Because electrolytic cells have finite useful lives, it is helpful (for at least warranty and diagnostic reasons) to have a life-hour counter that tallies the total number of hours a cell has been energized. Conventional counters tally only the total time a cell has been energized, regardless of the energization conditions. Hence, a conventional counter would tally, for example, two hours of energization even if one hour was at 100% and the second hour was at 50%.

At least one version of the present invention gathers data not merely as to whether a cell is energized, but also at what level of energization the cell is energized. To avoid excess memory needs, energization levels may be divided into increments (“buckets”) of desired size. One preferred division may be every 10% of energization—i.e. bucket 1 may be when the cell is energized between 91-100%, bucket 2 may be 81-90% energization, bucket 3 may be 71-80% energization, . . . down to bucket 10, which may be 0-10% energization. The operating time (e.g., in seconds) of the cell in each of these buckets may be accumulated and stored in servant device 2 and/or transferred to master device 1. Similar data divisions and collection schemes may exist for other aspects of the SWC or the water passing therethrough.

The foregoing is provided for purposes of illustrating, explaining, and describing embodiments of the present invention. Modifications and adaptations to these embodiments will be apparent to those skilled in the art and may be made without departing from the scope or spirit of the invention. Finally, references to “pools” and “swimming pools” herein may also refer to spas or other water containing vessels used for recreation or therapy and in connection with SWCs are used.

What is claimed is:

1. A method of effecting communication between a master device and a first component of a water-circulation system of a swimming pool or spa, comprising:
a. providing a two-wire electrical connection between the first component and the master device;
b. causing a first modulated signal to be transmitted from the master device to the first component; and
c. causing a second modulated signal to be transmitted from the first component to the master device.

2. A method according to claim 1 in which the first component is a salt water chlorinator.

3. A method according to claim 1 in which modulation of the first modulated signal differs from modulation of the second modulated signal.

4. A method according to claim 3 in which the voltage of the first modulated signal is modulated and the current of the second modulated signal is modulated.

5. A method according to claim 2 in which the first modulated signal supplies both power and first data to the salt water chlorinator.

6. A method according to claim 5 in which the second modulated signal supplies second data from the salt water chlorinator.

7. A method according to claim 1 in which the two-wire electrical connection comprises first and second wires, the first wire functioning as a ground wire and the second wire functioning to convey power and data.

8. A method according to claim 7 in which the first component comprises a salt water chlorinator comprising an electrolytic cell including a plurality of plates, further comprising providing third- and fourth-wire electrical connection between the salt water chlorinator and the master device, with the third- and fourth-wire electrical connection supplying power to the plurality of plates.

9. A method according to claim 1 in which the second modulated signal comprises data relating to a length of operation and an energization level of the first component.

10. A method according to claim 1 in which the second modulated signal comprises time-varying data relating to operation of the first component.

11. A method according to claim 1 in which the second modulated signal comprises data relating to the authenticity of the first component.

12. A communications system comprising:
a. a first component of a water-circulation system of a swimming pool or spa;
b. a master device; and
c. a two-wire electrical connection between the first component and the master device configured to transmit a first modulated signal from the master device to the first component and a second modulated signal from the first component to the master device.

13. A communications system according to claim 12 in which the master device comprises:
a. a first computerized controller;
b. a first detecting device; and
c. a voltage modulator.

14. A communications system according to claim 13 in which the first component comprises a salt water chlorinator comprising:
a. a second computerized controller; and
b. a second detecting device.

15. A communications system according to claim 14 in which the first detecting device is configured to detect and demodulate data received from the salt water chlorinator.
